(19) United States
(12) Patent Application Publication
(10) Pub. No.: US 2007/0109696 A1
(43) Pub. Date: May 17, 2007

(54) Ground fault circuit interrupt device

(75) Inventor: Warren L. Williamson, Mesa, AZ (US)

Correspondence Address: ROGITZ & ASSOCIATES, 750 B STREET, SUITE 3120, SAN DIEGO, CA, 92101, US

(73) Assignee: JP NOLAN & COMPANY

(21) Appl. No.: 11/273,138

(22) Filed: Nov. 14, 2005

(51) Int. Cl. H02H 3/00

(52) U.S. Cl. 361/42

(57) ABSTRACT

A GFCI circuit for a 120/240 volt application employs a window comparator to trip the circuit when voltage is too high or too low, in addition to a current sensing transformer tripping the circuit on a ground fault. The tripping relay drops out before the circuit does, so that if insufficient voltage exists to operate the circuit, the relay will have first opened the line to the loads.

### FIELD OF THE INVENTION

The present invention relates generally to ground fault circuit interrupt (GFCI) devices, and more particularly to GFCI devices that retain functionality in 120/240 volt applications under broken neutral and reversed line/neutral conditions.

### BACKGROUND

Ground fault circuit interrupter (GFCI) devices are used to open the circuit between a power supply and a load when a ground fault condition is detected. In the most basic application, a GFCI device receives a “hot” line, usually 120 volts, and a neutral line as input, with the GFCI device including a pair of terminals, typically embodied in a socket, to which an electrical load such as an electrical tool can be connected.

In certain fields, such as the construction industry, multiple loads, e.g., power saws, power drills, jackhammers, and arc welders, may require power, and it is convenient to power these tools using a single junction box, colloquially referred to as a “spider box”. A spider box typically has a single neutral input and two or more 120 volt “live” inputs, such that as between two “live” inputs, a 240 volt differential exists.

This arrangement presents challenges in terms of ground fault interruption, however, because two possibilities arise that can compromise the operation of a GFCI device. The first is a broken neutral input, which can happen as a spider box is moved around a construction site. The second possibility is that when a technician connects the inputs, he might unintentionally reverse the neutral line with one of the “live” power lines. The result is that depending on whether the loads are balanced (and usually they are not), either insufficient voltage may be present to operate the GFCI circuit, or the circuit and load can be exposed to excessively high voltage, which can damage them.

U.S. Pat. No. 6,021,034 teaches away from using a separate GFCI device for each “live” power line based on the contention that nuisance tripping can occur, and instead proposes to solve the problems noted above by providing an arrangement whereby power circuits must be operated in pairs. This is less than satisfactory.

### SUMMARY OF THE INVENTION

A GFCI device has a current transformer engaged with both a power line and a neutral line, and a logic component communicates with the current transformer and causes the circuit between a power supply connected to the power line and an electrical load to open based on input from the transformer. A comparator such as a window comparator communicates with the logic component and sends a signal to the logic component to cause it to open the circuit between the power supply and load when a voltage in the device exceeds a maximum voltage threshold. Also, the window comparator provides undervoltage protection by sending a signal to the logic component to cause it to open the circuit between the power supply and load when a voltage in the device falls below a minimum voltage threshold.

In non-limiting implementations a bridge rectifier supplies power to the logic component. The logic component can control a relay to selectively open the circuit between the power supply and load. In specific non-limiting implementations the logic component controls a switch and the switch is connected to one or more transistors, which in turn are connected to the relay to actuate it.

In the preferred non-limiting embodiment the relay has a drop-out voltage that is higher than the voltage necessary to operate the GFCI circuit, so that the relay drops out and opens the circuit to the load before the GFCI circuit stops functioning due to insufficient voltage. Moreover, with the structure summarized above, if the neutral line is broken and the GFCI device is connected to another GFCI device through a virtual neutral, and if a load imbalance occurs to cause an overvoltage or undervoltage condition, the window comparators cause each GFCI device to open the respective circuit to its respective load. Likewise, if an overvoltage condition exists due to a power line being connected to a neutral line terminal and vice-versa, the GFCI device opens the circuit to its load.

In another aspect, a 120/240 volt junction box has a first 120 volt line connected to a first GFCI device for powering a first load except under ground fault conditions, in which case the first GFCI device opens a circuit between the first 120 volt line and the first load. A second 120 volt line is connected to a second GFCI device for powering a second load except under ground fault conditions, in which case the second GFCI device opens a circuit between the second 120 volt line and the second load. A neutral line is connected to both devices, and first means are provided in the first GFCI device for preventing malfunctioning of the first GFCI device in the presence of a ground fault if the neutral line is broken and furthermore for preventing malfunctioning of the first GFCI device in the presence of a ground fault if the neutral line is reversed with one of the 120 volt lines. Similarly, second means are provided in the second GFCI device for preventing malfunctioning of the second GFCI device in the presence of a ground fault if the neutral line is broken and for preventing malfunctioning of the second GFCI device in the presence of a ground fault if the neutral line is reversed with one of the 120 volt lines.

In still another aspect, a method for establishing ground fault protection for first and second loads connected to a junction box includes disposing a first relay contact in a first 120 volt line connected to the first load, disposing a second relay contact in a second 120 volt line connected to the second load, connecting the first load to the first 120 volt line, and connecting the second load to the second 120 volt line. The method further contemplates connecting both loads to a neutral line. The contacts are controlled using respective logic components, with the method including using respective transformers to generate signals to the respective logic components to cause them to open the respective contacts when a ground fault occurs. The method also includes using a first window comparator to send a fault signal to the first logic component when an overvoltage condition occurs and using the first window comparator to send a fault signal to the first logic component when an undervoltage condition occurs. As set forth further below, the method contemplates using a second window comparator to send a fault signal to the second logic component when an overvoltage condition occurs, and using the second window comparator to send a fault signal to the second logic component when an undervoltage condition occurs.

In another aspect, a GFCI device includes a current transformer engaged with at least one power line and a neutral line, and at least one comparator generating a signal to open a circuit between the power supply and an electrical load connected thereto when at least one voltage in the device exceeds a maximum voltage threshold, and/or when at least one voltage in the device falls below a minimum voltage threshold.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system; and

FIG. 2 is an electrical schematic of one exemplary non-limiting implementation of the present system.

### DETAILED DESCRIPTION OF THE PREFERRED EMBODIMENT

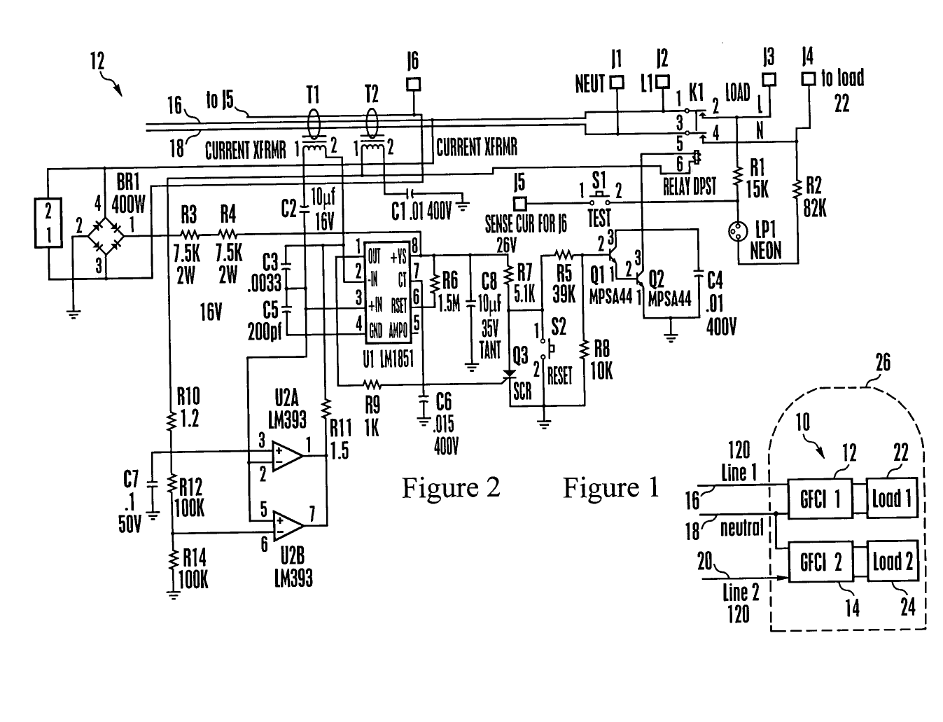

Referring initially to FIG. 1, a system is shown, generally designated 10, that includes a first GFCI device 12 in accordance with the present invention and a second GFCI device 14 that may be substantially identical to the first device 12 in configuration and operation. The first GFCI device 12 receives 120 volt power on a first power line 16 and also receives a neutral line 18. The second GFCI device 14 receives 120 volt power on a second power line 20 and is connected the neutral line 18. The first GFCI device 12 may have a socket for connecting to a first electrical load 22 while the second GFCI device 14 may have a socket for connecting to a second electrical load 24. Both GFCI devices 12, 14 may be located in a junction box 26, and with the arrangement shown the system 10 essentially is a 120/240 volt system. Additional power lines may be provided, with additional respective GFCI devices, or additional GFCI devices may be provided and associated with the same power lines.

FIG. 2 shows a non-limiting implementation of the GFCI device 12. It is to be understood that the numerical values and component part numbers shown in the diagram are not limiting, and are provided for illustrating one non-limiting implementation.

Power is received as shown along the lines 16, 18 as previously described. The lines 16, 18 pass through the core of a toroidal current transformer T1, which is electrically connected to a logic component U1 which may be, without limitation, a type LM1851 component made by National Semiconductor. In the embodiment shown, the logic component U1 as well as the below-described SCR Q1 and transistors Q2, Q3 receive rectified power from the lines 16, 18 through a bridge rectifier BR1, which is connected to the lines 16, 18, logic component U1, and additional components of the circuit as shown.

The transformer T1 may be, without limitation, a 1000-to-one step up transformer. When the current flowing through the power line 16 equals the current flowing through the neutral line 18 as it should under normal operating conditions, the transformer T1 does not send a signal to the logic component U1 to trip the circuit.

When a ground fault exists, however, the currents will not balance, causing a voltage to be generated by the transformer T1 which is interpreted by the logic component U1 to be a trip signal. Under these circumstances, the logic component U1 turns on a switch, such as the non-limiting silicon-controlled rectifier (SCR) Q3 to which the logic component U1 is connected as shown. In turn, in the non-limiting illustrative implementation shown the SCR Q3 deenergizes transistors Q1, Q2 to which the SCR is connected. These transistors normally (i.e., when no fault exists) are energized. The transistors Q1, Q2 in turn are connected to a relay K1 as shown, and when they are deenergized, the relay K1 is deenergized, opening associated contacts that are disposed as shown in the power line 16 and neutral line 18 between the power source, which taps into the power line 16 at input power terminal J2 and into the neutral line 18 at input neutral terminal J1, and load terminals J3, J4. As used herein, the term “relay” can refer to the relay coil proper and to the coil plus contacts that are actuated when the coil is energized and deenergized.

To test the operation of the relay K1, a manually operable test switch S1 is provided in a test line that extends between test terminals J5 and J6, it being understood that the terminals J5, J6 are connected together by a conductor passing through the transformer T1. When a person depresses the test switch S1, the logic component U1 senses a fault signal and causes the relay K1 to trip in accordance with the above disclosure. A reset switch S2 may be depressed to reset the circuit by deenergizing the SCR Q3.

Additional non-limiting features of the GFCI device 12 may include a power lamp LP1, which is illuminated when the relay K1 is not tripped to indicate the availability of power at the load terminals J3, J4. Also, a transient protection circuit MV1 may be provided in parallel with the bridge rectifier BR1 as shown for protecting the circuitry from power transients. Moreover, in non-limiting implementations a second transformer T2 can be provided through which the lines 16, 18 extend and which can be connected to the logic component U1 and relay K1 as shown for generating a trip current to the logic component U1 to cause it to trip the relay K1 in the event that the neutral line 18 is shorted to earth ground.

In accordance with the present invention, a comparator is provided to ensure proper GFCI functioning in a 120/240 volt arrangement in the event of either a broken neutral line 18 or a reversed power line 16/neutral line 18 error. With more specificity directed toward the preferred non-limiting embodiment shown in FIG. 2, two comparators U2A, U2B are provided in a window comparator configuration to send signals to the logic component U1. In the absence of over-voltages/under-voltage conditions, both comparators are “off”, i.e., their outputs to the logic component U1 are both high. However, when voltage falls below a low voltage threshold, one of the comparators outputs a low signal, which signals the logic component U1 to energize the SCR Q3 and open the circuit between the input terminals J1, J2 and load terminals J3, J4 in accordance with previous discussion. Similarly, when voltage exceeds a high voltage threshold, the other comparator outputs a low signal to signal the logic component U1 to open the circuit to the load terminals. The thresholds are established by the values of the resistors R10, R12, R14. The non-limiting values shown in FIG. 2 establish the high voltage threshold to be 156 volts and the low voltage threshold to be 78 volts.

It may now be appreciated that if the neutral line 18 is broken and the GFCI devices 12, 14 shown in FIG. 1 are essentially connected through a “virtual” neutral, the voltage between the power lines 16 of each device 12, 14 will be 240 volts. In the unlikely event that the loads are balanced, the GFCI devices operate normally in accordance with the above disclosure. However, should a load imbalance in the presence of a broken neutral cause an overvoltage or undervoltage condition, the window comparator will cause each device to trip, i.e., to open the circuit to its respective load. Likewise, if an overvoltage condition exists due to a power line 16 being connected to a neutral line terminal and vice-versa, the GFCI devices will trip on overvoltage. Furthermore, in accordance with present principles, the relay K1 of a GFCI device must have a minimum (“drop-out”) voltage at which it operates, and the operating voltage below which the GFCI circuit will not function is below the relay drop-out voltage, so that the relay drops out (and opens the circuit to the load) before the GFCI circuit stops functioning due to insufficient voltage from the bridge rectifier BR1.

While a window comparator is shown that uses an LM393 integrated circuit comparator, the term “comparator” as used herein also includes, e.g., a Zener diode with associated transistor that can generate a signal to trip the SCR without the need for the logic component U1. Further, while the preferred implementation envisions a window comparator, a single threshold implementation that uses only one of the comparators U2A, U2B is envisioned.

While the particular GROUND FAULT CIRCUIT INTERRUPT DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A GFCI device, comprising:
a current transformer engaged with at least one power line and a neutral line;
a logic component communicating with the current transformer and causing a circuit between an electrical load and a power supply connected to the power line to open based on input from the transformer; and
at least one comparator communicating with the logic component and sending a signal to the logic component to cause it to open a circuit between the power supply and electrical load when at least one voltage in the device exceeds a maximum voltage threshold, and/or the comparator also sending a signal to the logic component to cause it to open the circuit between the power supply and electrical load when at least one voltage in the device falls below a minimum voltage threshold.

2. The GFCI device of claim 1, further comprising a bridge rectifier supplying power to the logic component.

3. The GFCI device of claim 2, wherein the logic component controls at least one relay to selectively open the circuit between the power supply and load.

4. The GFCI device of claim 3, wherein the logic component controls a switch to selectively open the circuit between the power supply and load.

5. The GFCI device of claim 4, wherein the switch is connected to at least one transistor, the transistor being connected to the relay.

6. The GFCI device of claim 3, wherein the relay has a drop-out voltage that is higher than the voltage necessary to operate the circuit including the logic component and window comparator so that the relay drops out and opens the circuit to the load before the GFCI circuit stops functioning due to insufficient voltage.

7. The GFCI device of claim 6, wherein the comparator is part of a window comparator and if the neutral line is broken and the GFCI device is connected to another GFCI device through a virtual neutral, and if a load imbalance occurs to cause an overvoltage or undervoltage condition, the window comparator causes each GFCI device to open the respective circuit to its respective load.

8. The GFCI device of claim 7, wherein if an overvoltage condition exists due to a power line being connected to a neutral line terminal and vice-versa, the GFCI device opens the circuit to its load.

9. A 120/240 volt junction box, comprising:
a first 120 volt line connected to a first GFCI device for powering at least a first load except under ground fault conditions, in which case the first GFCI device opens a circuit between the first 120 volt line and the first load;
a second 120 volt line connected to a second GFCI device for powering at least a second load except under ground fault conditions, in which case the second GFCI device opens a circuit between the second 120 volt line and the second load;
a neutral line connected to both devices; and
first means in the first GFCI device for preventing malfunctioning of the first GFCI device in the presence of a ground fault if the neutral line is broken and for preventing malfunctioning of the first GFCI device in the presence of a ground fault if the neutral line is reversed with one of the 120 volt lines; and
second means in the second GFCI device for preventing malfunctioning of the second GFCI device in the presence of a ground fault if the neutral line is broken and for preventing malfunctioning of the second GFCI device in the presence of a ground fault if the neutral line is reversed with one of the 120 volt lines.

10. The junction box of claim 9, wherein the first means includes a comparator.

11. The junction box of claim 10, wherein the first means includes a relay controlled by a logic component to selectively open the circuit between the first power line first load, wherein the relay has a drop-out voltage that is higher than the voltage necessary to operate the circuit including the logic component and comparator so that the relay drops out and opens the circuit to the load before the GFCI circuit stops functioning due to insufficient voltage.

12. The junction box of claim 11, wherein the logic component controls a switch to selectively open the circuit between the power line and first load.

13. The junction box of claim 12, wherein the switch is connected to at least one transistor, the transistor being connected to the relay.

14. A method for establishing ground fault protection for first and second loads connected to a junction box, comprising:
disposing a first relay contact in a first 120 volt line connected to the first load;
disposing a second relay contact in a second 120 volt line connected to the second load;
connecting the first load to the first 120 volt line;
connecting the second load to the second 120 volt line;
connecting both loads to a neutral line;
controlling the first contact using a first logic component;
controlling the second contact using a second logic component;
using a first transformer to generate a signal to the first logic component to cause it to open the first contact when a ground fault occurs;
using a second transformer to generate a signal to the second logic component to cause it to open the second contact when a ground fault occurs;
using a first window comparator to send a fault signal to the first logic component when an overvoltage condition occurs;
using the first window comparator to send a fault signal to the first logic component when an undervoltage condition occurs;
using a second window comparator to send a fault signal to the second logic component when an overvoltage condition occurs; and
using the second window comparator to send a fault signal to the second logic component when an undervoltage condition occurs.

15. The method of claim 14, wherein the window comparators open their respective contacts in the presence of a respective fault signal.

16. The method of claim 14, comprising actuating the contacts with respective first and second relay coils, each relay coil having a drop-out voltage higher than the voltage necessary to operate the logic components.

17. The method of claim 14, comprising supplying power to the logic components using respective bridge rectifiers.

18. The method of claim 14, comprising using the logic components to control respective switches to selectively open the circuit between the respective 120 volt lines and respective loads.

19. The method of claim 18, comprising connecting the switches to respective transistors, the transistors being connected to respective relays actuating the respective contacts.

20. A GFCI device, comprising:
a current transformer engaged with at least one power line and a neutral line; and
at least one comparator generating a signal to open a circuit between the power supply and an electrical load connected thereto when at least one voltage in the device exceeds a maximum voltage threshold, and/or the comparator also generating a signal to open the circuit between the power supply and electrical load when at least one voltage in the device falls below a minimum voltage threshold.

21. The device of claim 20, comprising a logic component communicating with the current transformer and causing a circuit between an electrical load and a power supply connected to the power line to open based on input from the transformer.
